(19) United States
(12) Patent Application Publication
(10) Pub. No.: US 2020/0201372 A1
(43) Pub. Date: Jun. 25, 2020

(54) DYNAMIC BIASING CONTROL SYSTEM

(71) Applicant: NUVOTON TECHNOLOGY CORPORATION, HSINCHU CITY (TW)

(72) Inventor: Hua-Chun TSENG, HsinChu Science Park (TW)

(21) Appl. No.: 16/723,617

(22) Filed: Dec. 20, 2019

(30) Foreign Application Priority Data
Dec. 21, 2018 (TW) 107146325

(51) Int. Cl. G05F 1/575

(52) U.S. Cl. CPC G05F 1/575

(57) ABSTRACT

A dynamic biasing control system applicable to a LDO is provided. The LDO includes an error amplifier, and an output terminal of the LDO outputs a first output voltage, and an output terminal of the error amplifier outputs a second output voltage. The dynamic biasing control system includes a differential amplifier for receiving the first output voltage, and generating a control voltage according to the first output voltage; a first adjustable current source for receiving the second output voltage and dynamically outputting a first current, according to the second output voltage, to drive the differential amplifier; a second adjustable current source for receiving the control voltage and dynamically outputting a second current according to the control voltage, to drive the error amplifier.

### CROSS-REFERENCE TO RELATED APPLICATION

This application claims the benefit of Taiwan Patent Application No. 107146325, filed on Dec. 21, 2018, in the Taiwan Intellectual Property Office, the disclosure of which is incorporated herein in its entirety by reference.

### BACKGROUND OF THE INVENTION

### 1. Field of the Invention

The present invention relates to a biasing circuit, more particularly to a dynamic biasing control system which is applicable to a voltage regulator to increase a response speed of the voltage regulator.

### 2. Description of the Related Art

Since there is limitation of design specification, a general voltage regulator, such as a low drop-out circuit (LDO), includes an error amplifier which has a dominant pole located at an output thereof under certain using condition, and it causes the response speed of the error amplifier to be slower. When a current required by a load of the LDO is changed more greatly, the output voltage of the LDO is also changed more greatly, and if the error amplifier does not respond to the voltage change in time, the output voltage of the LDO may be excessively high or low to cause damage or abnormal operation of the circuit which is supplied power by the LDO.

### SUMMARY OF THE INVENTION

In order to solve aforementioned conventional problem, the present invention provides a dynamic biasing control system to effectively increase a response speed of a low drop-out circuit for a load change in actual application.

According to an embodiment, the present invention provides a dynamic biasing control system applicable to a low drop-out circuit which includes an error amplifier. An output terminal of the low drop-out can output a first output voltage, the error amplifier outputs a second output voltage, and the dynamic biasing control system includes a differential amplifier a first adjustable current source, and a second adjustable current source. The differential amplifier is configured to receive the first output voltage, and generate a control voltage according to the first output voltage. The first adjustable current source is configured to receive the second output voltage, and dynamically output a first current according to the second output voltage, to drive the differential amplifier. The second adjustable current source is configured to receive the control voltage, and dynamically output a second current according to the control voltage, to drive the error amplifier.

According to an embodiment, the dynamic biasing control system can comprise a voltage follower electrically connected between an output terminal of the low drop-out circuit and the differential amplifier, and the differential amplifier receives the first output voltage through the voltage follower.

According to an embodiment, the first adjustable current source can comprise a first fixed current source and a first controllable current source, and the first fixed current source and the first controllable current source are parallelly connected between a power supply terminal and the differential amplifier, and the current outputted from the first controllable current source is controlled by the second output voltage, to dynamically adjust the first current.

According to an embodiment, the low drop-out can comprise a driving transistor, the first controllable current source comprises a first transistor, and the driving transistor and the first transistor are electrically connected to each other to form a current mirror circuit.

According to an embodiment, the driving transistor and the first transistor are electrically connected to an output terminal of the error amplifier.

According to an embodiment, the error amplifier can comprise a positive input configured to receive the feedback voltage, and a negative input configured to receive the reference voltage, the feedback voltage is a divided voltage of the first output voltage, and when the first output voltage is dropped and the second output voltage is also dropped correspondingly to turn on the first transistor, the first current outputted from the first controllable current source is increased.

According to an embodiment, the second adjustable current source can comprise a second fixed current source and a second controllable current source, the second fixed current source and the second controllable current source are parallelly connected between the error amplifier and low voltage terminal, the current outputted from the second controllable current source is controlled by the control voltage to dynamically adjust the second current.

According to an embodiment, the second controllable current source can comprise a second transistor, and when the second transistor is turned on by the control voltage, the second current outputted from the second controllable current source is increased.

According to an embodiment, when the first output voltage is dropped, the control voltage generated by the differential amplifier rises.

### BRIEF DESCRIPTION OF THE DRAWINGS

The structure, operating principle and effects of the present invention will be described in detail by way of various embodiments which are illustrated in the accompanying drawings.

FIG. 1 is a block diagram of a dynamic biasing control system of the present invention.

FIG. 2 is a block diagram of an embodiment of a dynamic biasing control system of the present invention.

FIG. 3 is a circuit diagram of an embodiment of a dynamic biasing control system of the present invention.

### DETAILED DESCRIPTION OF THE PREFERRED EMBODIMENTS

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims. These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts.

It is to be acknowledged that although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes any and all combinations of one or more of the associated listed items.

It will be acknowledged that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the word “comprise” and variations such as “comprises” or “comprising”, will be acknowledged to imply the inclusion of stated elements but not the exclusion of any other elements.

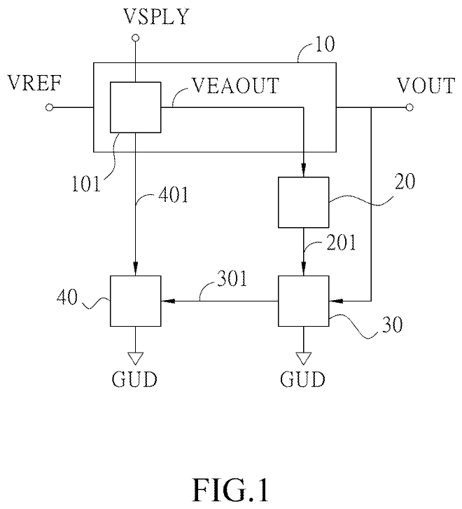

Please refer to FIG. 1, which is a block diagram of a dynamic biasing control system of the present invention. As shown in FIG. 1, the dynamic biasing control system can comprise a differential amplifier 30, a first adjustable current source 20 and a second adjustable current source 40. The dynamic biasing control system is applicable to a low drop-out circuit 10, and can quickly adjust a driving current of the differential amplifier 30, and a driving current of an error amplifier 101 of the low drop-out circuit 10 when an output voltage VOUT of the low drop-out circuit 10 has obvious change, thereby increasing a response speed of the low drop-out circuit 10.

The differential amplifier 30 can receive the output voltage VOUT of the output terminal of the low drop-out circuit 10, and generate a control voltage 301 according to the output voltage VOUT. The first adjustable current source 20 can receive an output voltage VEAOUT of the error amplifier 101 and dynamically output a first current 201 according to the output voltage VEAOUT, so as to drive the differential amplifier 30. The second adjustable current source 40 can receive the control voltage 301 and dynamically output a second current 401 according to the control voltage 301, so as to drive the error amplifier 101.

In an actual application, when the load of the low drop-out circuit 10 becomes heavy and draws more current, it causes drop of the output voltage VOUT. Therefore, the low drop-out circuit 10 has a feedback mechanism, which is not shown in FIG. 1, the output voltage VOUT is fedback to the error amplifier 101, when the output voltage VOUT is dropped, the output voltage VEAOUT of the error amplifier 101 is also dropped, so the low drop-out circuit 10 outputs more current to rise the output voltage VOUT.

When the low drop-out circuit 10 has a faster response speed, the effect caused by drop of the output voltage VOUT can be less. In the dynamic biasing control system of the present invention, when the output voltage VOUT is dropped, the output voltage VEAOUT of the error amplifier 101 is also dropped, so the first adjustable current source 20 can increase a first current 201 to improve the response speed of the differential amplifier 30, thereby outputting the control voltage 301 faster. The control voltage 301 outputted from the differential amplifier 30 can rise in response to drop of the output voltage VOUT, so that the second adjustable current source 40 increases the second current 401, thereby increasing the response speed of the error amplifier 101.

According to aforementioned mechanism, when the output voltage VOUT is dropped, the dynamic biasing control system of the present invention can improve the response speeds of the error amplifier 101 and the differential amplifier 30, thereby increasing the response speed of the low drop-out circuit 10.

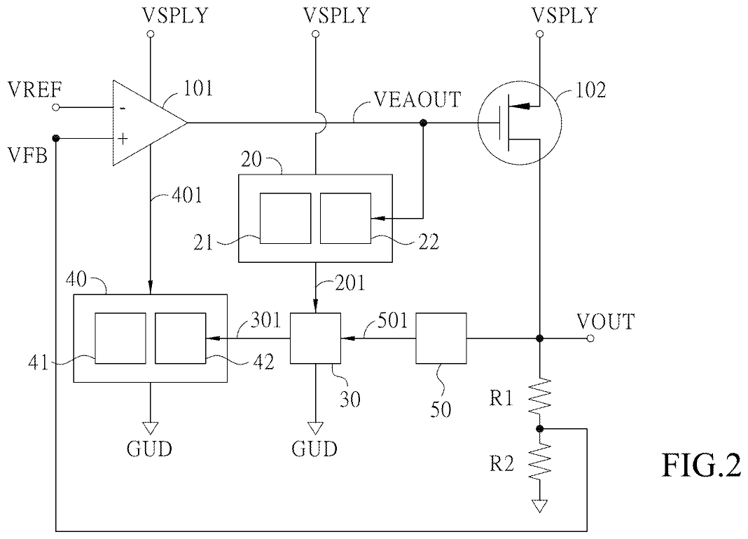

Please refer to FIG. 2, which is a block diagram of an embodiment of a dynamic biasing control system of the present invention. As shown in FIG. 2, the low drop-out circuit can comprise an error amplifier 101, a driving component 102 and resistors R1 and R2. The driving component 102 is electrically connected between a power supply terminal, which has a power supply voltage VSPLY, and resistor R1. A node between the driving component 102 and the resistor R1 can serve as an output terminal of the low drop-out circuit, and the voltage of the output terminal is the output voltage VOUT. In an embodiment, the driving component 102 can be implemented by a power transistor.

The resistors R1 and R2 can form a voltage divider for generating a divided voltage of the output voltage VOUT on the node between the resistors R1 and R2, and the divided voltage serves as a feedback voltage VFB. The feedback voltage VFB is inputted to a positive input of the error amplifier 101, and a reference voltage VREF is inputted to a negative input of the error amplifier 101. The error amplifier 101 has a positive power terminal for receiving the power supply voltage VSPLY, and a negative power terminal electrically connected to the second adjustable current source 40. The second adjustable current source 40 can provide the second current 401 to drive the error amplifier 101.

In the embodiment, the dynamic biasing control system can comprise a voltage follower 50 electrically connected between the output terminal of the low drop-out circuit and the differential amplifier 30, and configured to provide buffer. The differential amplifier 30 can receive a voltage 501 which is substantially equal to the output voltage VOUT; in other words, the differential amplifier 30 receives the output voltage VOUT through the voltage follower 50, so as to isolate the load from affecting the differential amplifier 30.

In the embodiment, the first adjustable current source 20 can comprise a first fixed current source 21 and a first controllable current source 22. The first fixed current source 21 and the first controllable current source 22 are parallelly connected between the power supply terminal and differential amplifier 30, and the current outputted from the first controllable current source 22 is controlled by the output voltage VEAOUT outputted from the error amplifier 101, thereby dynamically adjusting the first current 201.

In the embodiment, the second adjustable current source 40 can comprise a second fixed current source 41 and a second controllable current source 42, the second fixed current source IB0 and the second controllable current source 42 are parallelly connected between the error amplifier 101 and a low voltage terminal. The current outputted from the second controllable current source 42 is controlled by the control voltage 301, thereby dynamically adjusting the second current 401.

When the output voltage VOUT is dropped, the feedback voltage VFB is also dropped, so that the output voltage VEAOUT of the error amplifier 101 is also dropped to cause more current outputted from the first controllable current source 22, and the first current 201 is also increased. After the first current 201 is increased, the response speed of the differential amplifier 30 can become faster, so that the drop of the output voltage VOUT can more quickly cause rise of the control voltage 301. The rise of the control voltage 301 can cause more current outputted from the second controllable current source 42, and the second current 401 is also increased. After the second current 401 is increased, the response speed of the error amplifier 101 can become faster, so that the response speed of the low drop-out circuit can become faster.

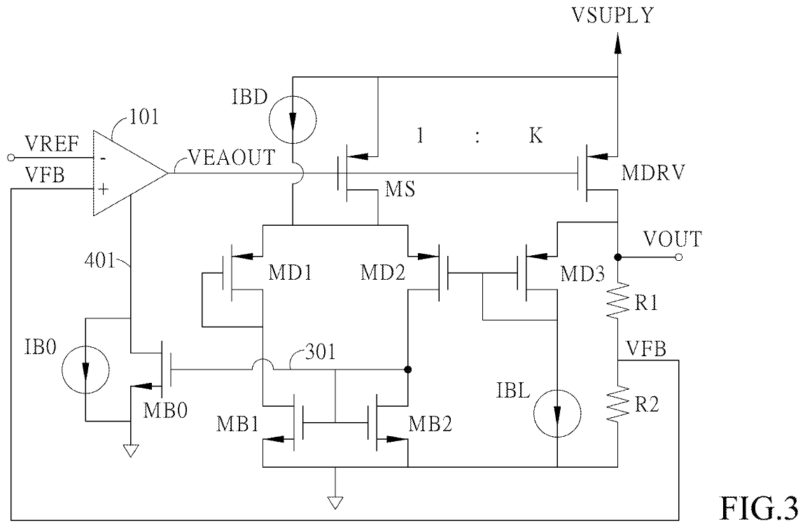

Please refer to FIG. 3, which is a circuit diagram of an embodiment of a dynamic biasing control system of the present invention. As shown in FIG. 3, the low drop-out comprise an error amplifier 101, a driving transistor MDRV, and resistors R1 and R2. In the embodiment, the driving transistor MDRV is implemented by P-type MOSFET. The gate of the driving transistor MDRV is electrically connected to the output terminal of the error amplifier 101, to receive the output voltage VEAOUT outputted from the error amplifier 101. The resistors R1 and R2 are connected in series between the drain of the driving transistor MDRV and ground.

The driving transistor MDRV is operated in a linear region, and the gate voltage of the driving transistor MDRV can be used to control an output current flowing through the driving transistor MDRV, and a part of the output current also flows through the resistors R1 and R2. A voltage on the node between the resistors R1 and R2 can serve as the feedback voltage and be inputted to the positive input of the error amplifier 101. The drain voltage of the driving transistor MDRV serves as the output voltage VOUT of the low drop-out circuit. The feedback voltage VFB is a divided voltage of the output voltage VOUT.

The negative input of the error amplifier 101 receives the reference voltage VREF. When the low drop-out circuit is connected to a heavy load and drawn a larger current, the current flowing through the resistors R1 and R2 becomes lower, so the output voltage VOUT is dropped and the feedback voltage VFB is also dropped, and the output voltage VEAOUT of the error amplifier 101 is dropped to cause the driving transistor MDRV to output more current, thereby increasing the voltage VOUT.

In the embodiment, the dynamic biasing control system comprise a first fixed current source IBD, a first transistor MS, a second fixed current source IB0, a second transistor MB0, a third transistor MD3, a third fixed current source IBL, a fourth transistor MD1, a fifth transistor MD2, a sixth transistor MB1, and a seventh transistor MB2. The first transistor MS, the third transistor MD3, the fourth transistor MD1 and the fifth transistor MD2 are implemented by P-type MOSFETs, and the second transistor MB0, the sixth transistor MB1 and the seventh transistor MB2 are implemented by N-type MOSFETs.

The gate of the first transistor MS is electrically connected to the output terminal of the error amplifier 101. The driving transistor MDRV and the first transistor MS are electrically connected to the output terminal of the error amplifier 101 to form a current mirror structure. The first fixed current source IBD and the first transistor MS can form the first adjustable current source.

In the embodiment, sizes of the driving transistor MDRV and the first transistor MS are in a ratio of 1:K; in other words, the current flowing through the driving transistor MDRV is K times of the current flowing through the first transistor MS, and when the current flowing through the driving transistor MDRV is changed, the current flowing through the first transistor MS is also changed.

The third transistor MD3 and the third fixed current source IBL can form a voltage follower circuit. The source of the third transistor MD3 is electrically coupled to the drain of the driving transistor MDRV, the gate and the drain of the third transistor MD3 are electrically connected to each other, and a current input terminal of the third fixed current source IBL is electrically connected to the drain of the third transistor MD3, and a current output terminal of the third fixed current source IBL is grounded.

The fourth transistor MD1, the fifth transistor MD2, the sixth transistor MB1 and the seventh transistor MB2 can form a differential amplifier circuit. The sources of the fourth transistor MD1 and the fifth transistor MD2 are electrically coupled to the drain of the first transistor MS and the current output terminal of the first fixed current source IBD. The gate and the drain of the fourth transistor MD1 are electrically connected to each other, and the gate of the fifth transistor MD2 is electrically coupled to the gate of the third transistor MD3. The sources of the sixth transistor MB1 and the seventh transistor MB2 are grounded, and the gates of the sixth transistor MB1 and the seventh transistor MB2 are electrically connected to each other and also electrically connected to the drain of the seventh transistor MB2. The drain of the sixth transistor MB1 is electrically coupled to the drain of the fourth transistor MD1, and the drain of the seventh transistor MB2 is electrically coupled to the drain of the fifth transistor MD2.

The gate of the third transistor MD3 receives the output voltage VOUT through the voltage follower. When the output voltage VOUT is dropped to make the current flowing through the fifth transistor MD2 rise, it causes rise of the drain voltage of the seventh transistor MB2 and the rise of the control voltage 301. The differential amplifier circuit formed by the fourth transistor MD1, the fifth transistor MD2, the sixth transistor MB1 and the seventh transistor MB2 can transfer the drop of the output voltage VOUT to the rise of the control voltage 301, so as to control the operational status of the second transistor MB0. When the response speed of the differential amplifier circuit becomes faster, the low drop-out circuit can respond the change of the load faster to adjust the output voltage VOUT, so as to achieve the effect of stabilizing the output voltage VOUT.

The second fixed current source IB0 and the second transistor MB0 can form the second adjustable current source. The second transistor MB0 has a gate electrically coupled the drain of the seventh transistor MB2, a source grounded and a drain electrically connected to a current input terminal of the second fixed current source IB0. The current output terminal of the second fixed current source IB0 is grounded. The positive power terminal of the error amplifier is electrically connected to the power supply terminal, and the negative power terminal of the error amplifier is electrically connected to the current input terminal of the second fixed current source IB0 and the drain of the second transistor MB0.

An operation of the embodiment is described in following paragraphs. When the low drop-out circuit is connected to a heavy load which draws a larger current, the current flowing through the resistors R1 and R2 becomes lower, so the output voltage VOUT and the feedback voltage VFB are dropped, so that the output voltage VEAOUT of the error amplifier 101 is dropped to cause the driving transistor MDRV and the first transistor MS to output more currents, so as to increase the response speed of the differential amplifier circuit. When the response speed of the differential amplifier circuit becomes faster, the control voltage 301 can rise faster in response to drop of the output voltage VOUT. When the control voltage 301 rises to exceed the threshold voltage of the second transistor MB0, the second transistor MB0 is turned on, so that the second current 401 can become larger to increase the response speed of the error amplifier 101. When the response speed of the error amplifier 101 becomes faster, the amplified voltage difference between the reference voltage VREF and the feedback voltage VFB can be generated faster, so as to increase the current outputted from the driving transistor MDRV. As a result, the low drop-out circuit can faster respond the load change to adjust the output voltage VOUT, so as to achieve the effect of stabilizing the output voltage VOUT.

When the first transistor MS outputs more current, it indicates that the differential amplifier formed by the fourth transistor MD1, the fifth transistor MD2, the sixth transistor MB1 and the seventh transistor MB2 can receive more current, and the response speed of the differential amplifier can be improved. When the second transistor MB0 is turned on by the control voltage 301, the current flowing through the second transistor MB0 can be combined with the current of the second fixed current source IB0, so as to increase the second current 401 outputted from the second controllable current source.

Furthermore, each of the first adjustable current source 20 and the second adjustable current source 40 of the present invention can be implemented by a combination of the fixed current source and the controllable current source. The fixed current source can limit the change of the current, for keeping stability of the low drop-out circuit. The controllable current source can increase the driving current of the circuit flexibly, for increasing the response speed of the low drop-out circuit.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. A dynamic biasing control system, applicable to a low drop-out circuit comprising an error amplifier, an output terminal of the low drop-out outputting a first output voltage, the error amplifier outputting a second output voltage, and the dynamic biasing control system comprising:
a differential amplifier configured to receive the first output voltage, and generate a control voltage according to the first output voltage;
a first adjustable current source configured to receive the second output voltage, and dynamically output a first current according to the second output voltage, to drive the differential amplifier; and
a second adjustable current source configured to receive the control voltage, and dynamically output a second current according to the control voltage, to drive the error amplifier.

2. The dynamic biasing control system according to claim 1, further comprising a voltage follower electrically connected between an output terminal of the low drop-out circuit and the differential amplifier, wherein the differential amplifier receives the first output voltage through the voltage follower.

3. The dynamic biasing control system according to claim 1, wherein the first adjustable current source comprises a first fixed current source and a first controllable current source, and the first fixed current source and the first controllable current source are parallelly connected between a power supply terminal and the differential amplifier, and the current outputted from the first controllable current source is controlled by the second output voltage, to dynamically adjust the first current.

4. The dynamic biasing control system according to claim 3, wherein the low drop-out comprises a driving transistor, the first controllable current source comprises a first transistor, and the driving transistor and the first transistor are electrically connected to each other to form a current mirror circuit.

5. The dynamic biasing control system according to claim 4, wherein the driving transistor and the first transistor are electrically connected to an output terminal of the error amplifier.

6. The dynamic biasing control system according to claim 4, wherein the error amplifier comprises a positive input configured to receive the feedback voltage, and a negative input configured to receive the reference voltage, the feedback voltage is a divided voltage of the first output voltage, and when the first output voltage is dropped and the second output voltage is also dropped correspondingly to turn on the first transistor, the first current outputted from the first controllable current source is increased.

7. The dynamic biasing control system according to claim 1, wherein the second adjustable current source comprises a second fixed current source and a second controllable current source, the second fixed current source and the second controllable current source are parallelly connected between the error amplifier and low voltage terminal, the current outputted from the second controllable current source is controlled by the control voltage to dynamically adjust the second current.

8. The dynamic biasing control system according to claim 7, wherein the second controllable current source comprises a second transistor, and when the second transistor is turned on by the control voltage, the second current outputted from the second controllable current source is increased.

9. The dynamic biasing control system according to claim 1, wherein when the first output voltage is dropped, the control voltage generated by the differential amplifier rises.
